(19) United States
(12) Patent Application Publication
(10) Pub. No.: US 2009/0173093 A1
(43) Pub. Date: Jul. 9, 2009

(54) Refrigerator

(75) Inventors: Susumu Sueda, Osaka (JP); Motohiko Sato, Tokyo (JP); Satoshi Okoso, Tokyo (JP)

Correspondence Address: CROWELL & MORING LLP;INTELLECTUAL PROPERTY GROUP, P.O. BOX 14300, WASHINGTON, DC, 20044-4300, US

(73) Assignees: FUKUSHIMA KOGYO CO., LTD., Osaka (JP); MEBIX INC., Tokyo (JP)

(21) Appl. No.: 11/912,766

(22) PCT Filed: Apr. 27, 2006
(86) PCT No.: PCT/JP2006/308897

§ 371 Date: Feb. 6, 2009

(30) Foreign Application Priority Data
Apr. 27, 2005 (JP) 2005-130301

(51) Int. Cl. G05D 23/00; F25D 17/06; F25D 25/02; F25D 23/02

(52) U.S. Cl. 62/157; 62/411; 62/465; 62/449

(57) ABSTRACT

A refrigerator capable of properly cooling a plurality of containers storing a liquid beverage by uniformizing and stabilizing a temperature inside a cooling chamber. The refrigerator comprises the cooling chamber storing the containers of the liquid beverage, a cooling duct incorporating a heat exchanger, the suction port of the cooling duct installed in the cooling chamber, the cool air blowout port of the cooling duct installed in the cooling chamber, a lead-in port formed at the upper end of a cool air feed duct, through holes blowing out the air in the cool air feed duct into the cooling chamber, and a fan positioned the lead-in port of the cool air feed duct. The cool duct sucks the air in the cooling chamber from the suction port, cools it by the heat exchanger, and blows it out from the cool air blowout port. The lead-in port of the cool air feed duct faces the cool air blowout port of the cooling duct and also faces the inside of the cooling chamber. Air is sucked into the cool air feed duct by the fan.

### BACKGROUND OF THE INVENTION

(1) Field of the Invention

The present invention relates to a refrigerator for cooling liquid drinks such as juice and alcohol.

(2) Description of the Related Art

As shown in Japanese Unexamined Patent Application Publication No. 2002-22333 (paragraphs 0028 to 0029), Japanese Unexamined Patent Application Publication No. 2001-325656 (paragraphs 0019 to 0020), and Japanese Unexamined Patent Application Publication No. 10-9739 (paragraphs 0017, FIG. 1), it is known to supercool liquid drinks to lower than or equal to a freezing point in a liquid phase, and instantly freeze the liquid drinks to a sorbet form by applying impact etc. on the liquid drinks. For instance, in Japanese Unexamined Patent Application Publication No. 10-9739 (paragraphs 0017, FIG. 1), the liquid drinks accommodated in a plurality of containers are supercooled in a refrigerator, and the liquid drinks are instantly frozen to a sorbet form when the container is taken out from the refrigerator and poured into a cup or the like.

### SUMMARY OF THE INVENTION

There is a limitation to a temperature range in which the liquid drinks can be supercooled in a liquid phase (e.g., −15 to −12° C. for alcoholic drinks). If the temperature of the liquid drink is lower than the limiting temperature, the liquid drink will freeze in the refrigerator. Therefore, the temperature inside the refrigerator must be uniformed to within the range of the limiting temperature in order to appropriately supercool all the liquid drinks accommodated in the plurality of containers. Furthermore, the supercooled liquid drinks are likely to be subjected to the influence of temperature change, and thus becomes difficult to be frozen to the sorbet form when poured into the cup etc. even if the temperature is just raised by a few degrees. Thus, the temperature change inside the refrigerator must be suppressed and the temperature must be stabilized. Specific configuration for uniforming the temperature inside the refrigerator and stabilizing the temperature is not described in Japanese Unexamined Patent Application Publication No. 2002-22333 (paragraphs 0028 to 0029), Japanese Unexamined Patent Application Publication No. 2001-325656 (paragraphs 0019 to 0020), and Japanese Unexamined Patent Application Publication No. 10-9739 (paragraphs 0017, FIG. 1).

Therefore, it is an object of the present invention to provide a refrigerator capable of appropriately cooling the liquid drinks by uniforming and stabilizing the temperature inside the refrigerator even if the liquid drinks are accommodated in the plurality of containers.

As shown in FIGS. 1 and 2, the present invention relates to a refrigerator including a cooling room for accommodating a container of liquid drink; a heat exchanger for cooling air inside the cooling room; a cooling duct incorporating the heat exchanger; an intake port (intake port on cooling means side) arranged on one part of the cooling duct; a cold air blow-out port arranged at a position different from the intake port of the cooling duct; a cold air supplying duct for circulating the air in the cooling room; an introducing port (intake port on the mixing unit side) arranged on one end of the cold air supplying duct; a vent hole for blowing out the air in the cold air supplying duct into the cooling room; and a fan attached facing the introducing port of the cold air supplying duct. The cooling duct takes in air in the cooling room from the intake port and cools the air through the heat exchanger, and blows out air from the cold air blow-out port. The cold air supplying duct is arranged in the up and down direction (vertical direction) of the cooling room at the far part of the cooling room, where the introducing port of the cold air supplying duct faces the cold air blow-out port of the cooling duct and faces the inside of the cooling room. Air is taken in from the introducing port of the cold air supplying duct into the cold air supplying duct by the fan.

Here, the refrigerator includes a case of supercooling the liquid drink, and a case of refrigerating the liquid drink in the supercooled state. One or a plurality of vent holes is formed as necessary. A site of the cooling room where the intake port of the cooling duct is arranged, is defined as the front part (front surface) of the cooling room, and the far part (rear surface) of the cooling room corresponds to the location spaced apart from the intake port such as the site on the back surface side or left and right side surfaces of the cooling room when the front surface of the cooling room is opened and the intake port is arranged on the opening side of the front surface. For instance, when the intake port is arranged at the site of one side surface of the left and right side surfaces, the site on the front and back surface side of the cooling room or on the side surface Aide opposite to the side surface on which the intake port is arranged corresponds to the far part.

Specifically, an opening area of the introducing port of the cold air supplying duct is larger than an opening area of the cold air blow-out port of the cooling duct, one part of the introducing port of the cold air supplying duct faces the cold air blow-out port of the cooling duct, and one part of the introducing port of the cold air supplying duct faces the inside of the cooling room.

An intake fan facing the intake port of the cooling duct is attached, and the air is taken in from the intake port of the cooling duct to the inside of the cooling duct by the intake fan. The amount of wind of the fan is set so as to be larger (e.g., 2 to 70% increase) than the amount of wind of the intake fan. The number of fan may be increased to increase the amount of wind.

More specifically, the front surface of the cooling room is opened, a door for opening/closing the front surface of the opening of the cooling room is arranged; the cooling duct is arranged on a roof side of the cooling room; the intake port of the cooling duct is arranged diagonally downward; the cold air blow-out port of the cooling duct is arranged downward; and the introducing port of the cold air supplying duct is arranged diagonally upward at the upper end of the cold air supplying duct, and faces the cold air blow-out port of the cooling duct.

Specifically describing, in the cooling room, a shelf plate is arranged in plurals in the up and down direction; the vent hole is arranged in plurals in the cold air supplying duct; and each vent hole is arranged dispersed in the up and down direction and in the left and right direction while facing a space on the upper side of the shelf plate of each upper and lower stage. Furthermore, the vent hole arranged in the space on the upper side of the shelf plate of each upper and lower stage supplies the cold air blown out from the cold air supplying duct into the cooling room in the up and down direction, that is, uniformly for each stage with the temperature inside the cooling room uniformed and stabilized, and to this end, the number and/or hole diameter of the vent hole is desirably set to reduce towards the stages on the upper side when the passage cross sectional area of the cold air supplying duct is relatively large (e.g., 16000 to 32000 mm²) or when the wind speed in the cold air supplying duct is relatively small (e.g., 0.7 to 3 m/sec). Furthermore, the number and/or hole diameter of the vent hole is desirably set to reduce towards the stages on the lower side when the passage cross sectional area of the cold air supplying duct is relatively small (e.g., 8000 to 16000 mm²) or when the wind speed in the cold air supplying duct is relatively large (e.g., 1.5 to 8 m/sec) in terms of uniforming the cold air blown out from the cold air supplying duct into the cooling room in the up and down direction. The number and the hole diameter of each vent hole may respectively be the same in the case corresponding to the middle of the above-mentioned numerical range (when the passage cross sectional area of the cold air supplying duct is relatively large and relatively small, or when the wind speed in the cold air supplying duct is relatively large and relatively small).

As shown in FIGS. 5 and 6, desirably, the front surface of the cooling room is opened, and the door for opening/closing the front surface of the opening of the cooling room and a plurality of curtains arranged lined in the up and down direction at the front surface of the opening of the cooling room are arranged to uniform and stabilize the temperature in the cooling room regardless of whether the door is opened or closed. More specifically, each curtain faces the space on the upper side of the shelf plate of each upper and lower stage.

The up and down length dimension of each curtain is desirably set so that a gap is formed between the curtain on the upper side and the curtain on the lower side to reduce the entering of the outside air into the cooling room with opening/closing of the door and to uniform and stabilize the temperature in the cooling room. Specifically, each curtain is hanged from a horizontal rod member bridged between the left and right side surfaces of the cooling room. More specifically, each curtain is formed with a plurality of cutouts extending vertically from a lower edge towards an upper edge side, and each cutout is formed with a constant spacing in the left and right direction (horizontal direction) of each curtain.

In terms of appropriately storing the uniformly and stably cooled liquid drink in the container in the present invention, a shelf receiving member supported by the inner surface of the cooling room and a vibration proofing material for covering the upper surface of the shelf receiving member are arranged in the cooling room, and the shelf plate is desirably mounted on the shelf receiving member by way of the vibration proofing material, as shown in FIG. 4.

Specifically, a shelf column is attached to the inner surface of the cooling room, and a plurality of attachment holes for attaching the shelf receiving member are arranged lined in the up and down direction at a side wall facing the shelf plate in the shelf column. Specifically, an upward projection is formed on an upper surface part of the shelf receiving member, and a fit-in hole to which the projection of the shelf receiving member is inserted is formed on the edge of the shelf plate. More specifically, the shelf column is attached to the front and the back (front surface side and rear surface side) of both left and right side surfaces (facing each other) at the inner surface of the cooling room, and the shelf plate is supported by the shelf receiving member engaged to the attachment hole of each shelf column on the front and back and the left and right.

Describing the specific configuration of each shelf receiving member, a distal end side of the upper surface part of each shelf receiving member is bent downward, and a basal end of the upper surface part of each shelf receiving member is bent upward, the lower end of each shelf receiving member is inserted to the attachment hole on the lower side of the shelf column so that the shoulder part of the lower end contacts the rim of the attachment hole, and the lower end of the shelf receiving member contacts the inner surface of the shelf column while being inserted to the attachment hole on the upper side of the shelf column, so that the shelf receiving member is engaged to the shelf column in a slip-off preventing manner.

In terms of uniforming and stabilizing the temperature in the cooling room, and appropriately cooling the liquid drink, a frame body including a peripheral frame formed along the peripheral edge of the upper surface of the shelf plate and a guide frame bridged (on the inner side) between the front and back frame parts of the peripheral frame is arranged on the upper surface of the shelf plate, where the guide frame is interposed between the containers adjacent to each other in the left and right direction, so that the cold air easily flows between the containers.

Desirably, the temperature inside is appropriately detected to uniform and stabilize the temperature inside the cooling room, and to this end, a temperature sensor facing the vent hole, and a control means for ON/OFF controlling a cooling device connected to the heat exchanger based on the temperature inside detected by the temperature sensor so that the temperature inside is within the temperature range set in advance, are desirably arranged.

The temperature sensor is desirably arranged in the vent hole facing the space on the upper side of the shelf plate on the upper most stage to more appropriately detect the temperature inside.

In order to uniform and stabilize the temperature inside the cooling room regardless of whether the door is opened/closed, the control means desirably stops the rotation of the intake fan and the fan when an open/close sensor detects that the door is opened.

A heater is arranged in the cooling room to have the change in temperature inside the cooling room gradual and to uniform and stabilize the temperature in the cooling room, where the control means desirably turns ON the heater HT when the temperature inside becomes the temperature (ON temperature) set in advance after the cooling device is turned ON. The temperature inside at which the cooling device is turned ON and the ON temperature may be the same. The control means then turns ON the heater HT, and thereafter, turns OFF the heater when the temperature inside becomes the OFF temperature set in advance that is lower than the ON temperature. Specifically, the OFF temperature is set to higher than or equal to the temperature inside at which the temperature inside lowers and the cooling device is turned OFF. The temperature inside at which the cooling device is turned OFF and the OFF temperature may be the same. The inside of the cooling room in which the heater HT is arranged includes the inside of the cold air supplying duct and the inside of the cooling duct connecting to the inside of the cooling room. Specifically, the heater is arranged in the cold air supplying duct. The heater may include a defrosting heater arranged in the heat exchanger, or the heater may be configured only with the defrosting heater.

A heat storage member having a relatively large heat storage capacity (e.g., 1.8 to 4.2 J/K) is desirably arranged in the cold air supplying duct to have the temperature change in the cooling room gradual and to uniform and stabilize the temperature inside the cooling room. The heat storage member is desirably arranged in the vicinity of the introducing port of the cold air supplying duct.

According to the present invention, the cold air (mixed cold air) is circulated into the cooling room with the cold air cooled in the cooling duct and the air of which temperature is raised by cooling the liquid drink in the cooling room are taken and mixed in the cold air supplying duct, thereby preventing one part in the cooling room from being cooled in excess with the cold air in the cooling duct, and furthermore, the cold air in the cooling duct and the air in the cooling room are well mixed thereby uniforming and stabilizing the temperature in the cooling room. Therefore, even if the liquid drinks are accommodated in a plurality of containers, the liquid drinks of all the containers can appropriately be cooled.

If the cold air is sent to the cold air supplying duct with the intake fan, and the amount of wind of the fan is larger than the amount of wind of the intake fan, the cold air in the cooling duct and the air in the cooling room are reliably taken into the cold air supplying duct, whereby the mixing of the cold air and the air in the cooling room is promoted, the circulating amount of air is increased, and the temperature in the cooling room is further uniformed and stabilized.

When the temperature sensor is arranged facing the vent hole, the temperature can be controlled to a more appropriate temperature inside than when the temperature sensor is attached on the inner surface etc. of the cooling room and the temperature is detected at the attached location. That is, the cold air blown out from the vent hole is a mixture of the cold air in the cooling duct and the air of which temperature is raised by cooling the container, and is close to the average of the temperature of such air. Thus, further uniforming and stabilization of the temperature in the cooling room can be achieved.

If the shelf plate is mounted on the shelf receiving member by way of the vibration proofing material, the vibration etc. is suppressed from being transmitted to the container through the shelf receiving member and the shelf plate, and the supercooled liquid drink is prevented from being frozen in the cooling room by vibration etc. That is, the liquid drink obtained by uniforming and stabilizing the temperature inside the cooling room is appropriately stored in the liquid phase.

If the guide frame is interposed between the containers adjacent (to each other) in the left and right, the cold air blown out from the vent hole more easily flows between the containers, the temperature in the cooling room is more uniformed and stabilized, and the liquid drink of each container is more appropriately cooled.

If the rotation of the intake fan and the fan is stopped when the door is opened, the temperature rise in the cooling room due to opening of the door is reduced, and the liquid drink obtained by uniforming and stabilizing the temperature inside the cooling room is more appropriately stored.

When the plurality of curtains is arranged lined in the up and down direction on the front surface of the opening of the cooling room, the entering of the outside air into the cooling room when the door is opened can be reduced by the arrangement of the curtains. Therefore, the temperature rise in the cooling room due to opening/closing of the door is suppressed, and further uniforming and stabilization of the temperature in the cooling room is achieved.

The difference in atmospheric pressure between the front and the back of the curtain becomes small by forming a gap between the upper and lower curtains, and thus the curtain is less likely to be taken into the cooling room side (rear surface side) when the door is closed. Therefore, the curtain is suppressed from closely attaching to the shelf plate or the inner surface of the cooling room, the effect of preventing the entering of outside air into the cooling room by the curtain is appropriately maintained, and the uniformed and stabilized state of the temperature in the cooling room is more reliably maintained.

The temperature change in the cooling room is made gradual and the temperature in the cooling room is uniformed and stabilized by turning ON the heater with the cooling device turned ON. In addition, the time interval of switching from ON to OFF of the cooling device becomes large by the amount of gradual lowering in the temperature inside, the number of ON/OFF switching of the compressor etc. of the cooling device decreases, and faults of the compressor etc. of the cooling device by frequent ON/OFF switching of the compressor etc. of the cooling device are reduced. The heater may be that in which the defrosting heater is arranged in the heat exchanger, or the heater may be configured only with the defrosting heater, so that the frost attached to the heat exchanger melts and can be removed.

When the heat storage member is arranged in the cold air supplying duct, the temperature fluctuation of the mixed cold air of the cold air blown out from the cooling duct and taken into the cold air supplying duct and the air taken into the cold air supplying duct from the cooling room is suppressed, the temperature fluctuation of the inside of the cooling room reduces therewith, and the uniformed and stabilized state of the temperature inside the cooling room is reliably maintained.

### BRIEF DESCRIPTION OF THE DRAWINGS

FIG. 1 shows a longitudinal side view of a refrigerator according to a first example of the present invention;

FIG. 2A shows a longitudinal side view of the main parts of the refrigerator of the first example;

FIG. 2B shows a partial enlarged view of FIG. 2A;

FIG. 3 shows a longitudinal front view of the main parts of the refrigerator;

FIG. 4 shows a longitudinal front view of a shelf receiving member;

FIG. 5 shows a longitudinal side view of a refrigerator according to a second example of the present invention;

FIG. 6 shows a longitudinal side view of the main parts of the refrigerator of the second example;

FIG. 7 shows a front view of a curtain according to the second example;

FIG. 8 shows a block configuration diagram of a control system according to the second example; and

FIG. 9 shows a timing chart describing the operation of a defrosting heater.

### DESCRIPTION OF THE PREFERRED EMBODIMENTS

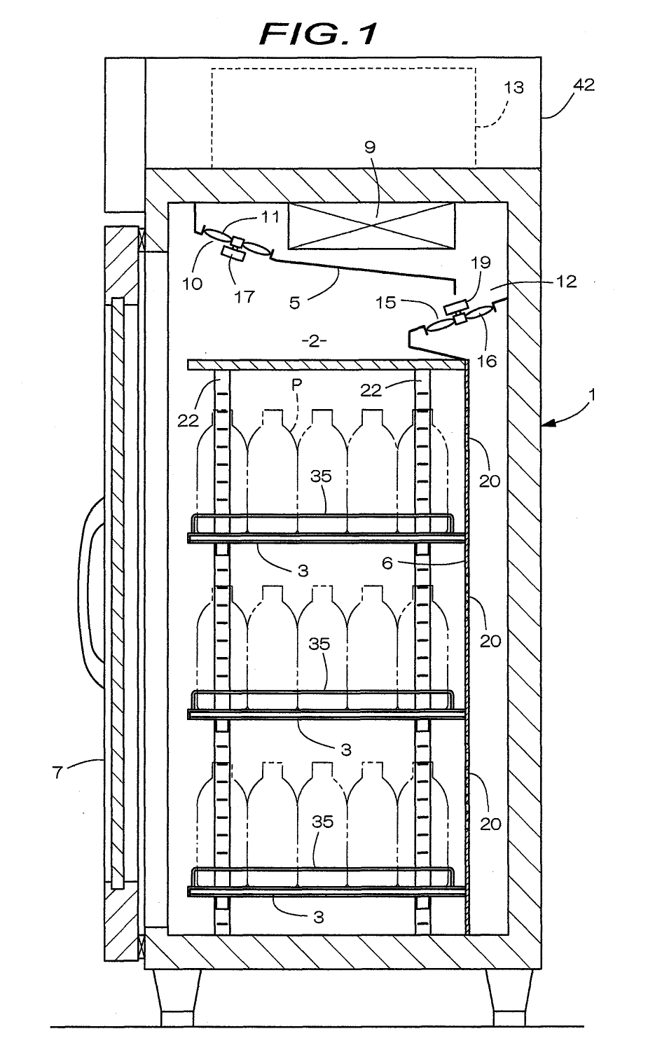

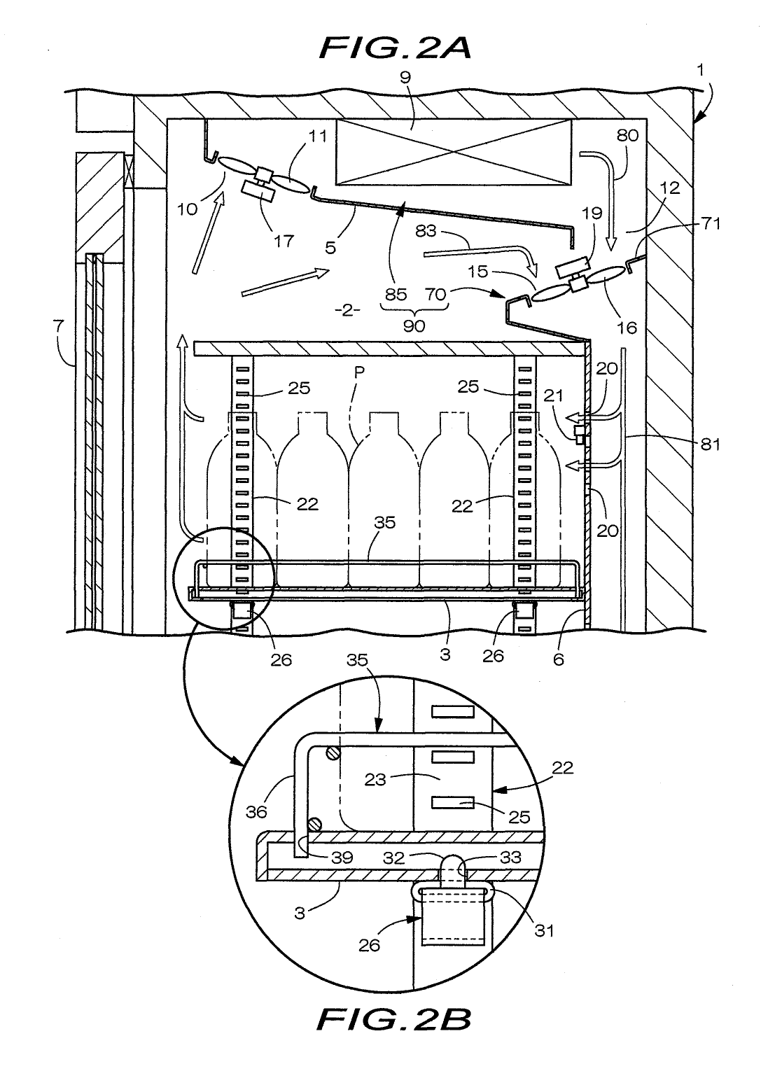

FIGS. 1 to 4 show a first example of a refrigerator, which is the object of the present invention. As shown in FIGS. 1 and 2, the refrigerator includes a cooling room 2 arranged in a refrigerator main body 1 and having a front surface opened, a plurality of shelf plates 3 arranged in a plural stages in the up and down direction in the cooling room 2, a cooling duct 5 for cooling one part of the air in the cooling room 2, a mixing unit 70 for mixing the cooled air (cold air) and part of the air in the cooling room 2, and a cold air supplying duct (cold air supplying means) 6 for supplying the cold air (mixed cold air) mixed in the mixing unit 70 into the cooling room 2. A door 7 with a transparent window that opens and closes the front surface of the opening is arranged on the front surface of the opening of the cooling room 2. The door 7 has a heat insulation structure.

A plurality of containers P such as plastic bottle, can, drink box, and bottle accommodating liquid drinks such as juice, coffee, tea, Japanese tea, oolong tea, milk, yogurt drink, mineral water, carbonated drink, and alcohol is arranged on each shelf plate 3. In other words, the containers P are lined from front to back and from side to side with respect to each shelf plate 3 when the cooling room 2 accommodates each container P in the cooling room 2. In the cooling room 2, each container P is stored at a temperature of lower than or equal to a freezing point of the liquid drink and in a supercooled state in which the liquid drink is maintained unfrozen. In this case, when the container P is taken out from the refrigerator, and applied with vibration or when the liquid inside the container P is poured into a cup etc., the liquid drink instantaneously freezes to a sorbet form. The freezing point of alcoholic drink etc. is about −15 to −3° C., and the freezing point of liquid drinks such as juice other than alcoholic drink is about −3 to 0° C. The temperature in the cooling room 2 is maintained at a predetermined temperature within the range of such freezing points.

The cooling duct 5 is arranged on the roof side of the cooling room 2. A heat exchanger 9 for cooling the air inside the cooling room 2 is incorporated in the cooling duct 5. The cooling duct 5 includes an intake port 10 for taking in one part of the cold air supplied to cool the liquid drink in the container P in the cooling room 2, and a cold air blow-out port 12 for blowing out the cold air taken in from the intake port 10. The intake port 10 of the cooling duct 5 is arranged diagonally downward at the front part of the cooling room 2, and an intake fan 11 is attached facing the intake port 10. The air is taken in from the intake port 10 of the cooling duct 5 into the cooling duct 5 with the intake fan 11. The cold air blow-out port 12 of the cooling duct 5 is arranged downward at the far part (rear surface side) of the cooling room 2. A first flow path 80 through which the air taken in passes is formed inside the cooling duct 5.

The heat exchanger 9 is connected to a cooling device 13 arranged on the upper side of the refrigerator main body 1. The cooling device 13 includes a compressor CP, a condensing unit 41, and an expansion valve, and is accommodated in a machine room 42 arranged on the upper side of the cooling room 2. The air inside the cooling room 2 is taken in from the intake port 10 of the cooling duct 5, cooled by the heat exchanger 9, and thereafter, blown out from the cold air blow-out port 12 of the cooling duct 5. Thus, the heat exchanger 9 can also be considered as a heat absorbing unit of the cooling device 13. A defrosting heater for removing frost attached to the heat exchanger 9 is arranged in the heat exchanger 9.

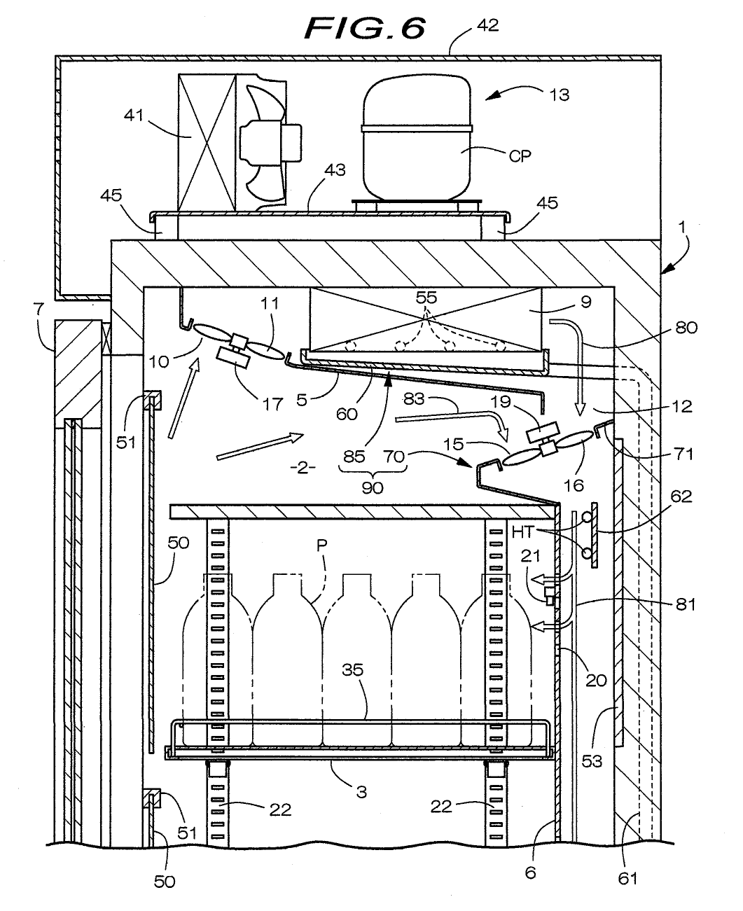

The cooling device 13 including the compressor CP, the condensing unit 41 and the like is fixed on a base plate 43 attached to the bottom-surface of the machine room 42 (see FIG. 6). The base plate 43 is attached on the upper side of the refrigerator main body 1 by way of a vibration proofing material 45 made of vibration proof rubber and the like. The vibration of the compressor CP etc. of the cooling device 13 is thus less likely to be transmitted to the refrigerator main body 1. The compressor CP is further attached to the base plate 43 by way of vibration proof rubber etc.

The cold air supplying duct 6 is arranged in the up and down direction at one side surface, or the far part in the present embodiment, of the cooling room 2. The mixing unit 70 (mixing main body 71) is arranged on the upper side of the cold air supplying duct 6. An introducing port 15 of the mixing unit 70 is arranged diagonally upward on the upper end (one end) side of the cold air supplying duct 6, and is faced (opened) to the cold air blow-out port 12 of the cooling duct 5. A pair of left and right fans 16 is attached facing the introducing port 15 of the mixing unit 70, so that the cold air blown out from the cold air blow-out port 12 and part of the air supplied to cool the liquid drink in the container P in the cooling room 2 are taken (introduced) into the mixing main body 71 from the introducing port 15 of the mixing unit 70 by the fan 16, and furthermore, the cold air (mixed cold air) taken in is introduced into the cold air supplying duct 6. The amount of combined wind of both fans 16 is set to be larger than the amount of wind of the intake fan 11. A DC motor having a small heat generation amount is used for a drive motor 17 of the intake fan 11 and a drive motor 19 of each fan 16. An inner wall of the cooling room 2 has a heat insulation structure. A second flow path 81 through which the cold air passes is formed inside the cold air supplying duct 6.

An opening area of the introducing port 15 of the mixing unit 70 is larger than an opening area of the cold air blow-out port 12 of the cooling duct 5. Thus, as shown in FIG. 1, one part of the introducing port 15 of the cold air supplying duct 6 faces the cold air blow-out port 12 of the cooling duct 5, and one part of the introducing port 15 of the cold air supplying duct 6 faces the inside of the cooling room 2. In other words, the cold air blown out from the cold air blow-out port 12 of the cooling duct 5 and the air inside the cooling room 2 are taken into the introducing port 15 of the cold air supplying duct 6 in a mixed state.

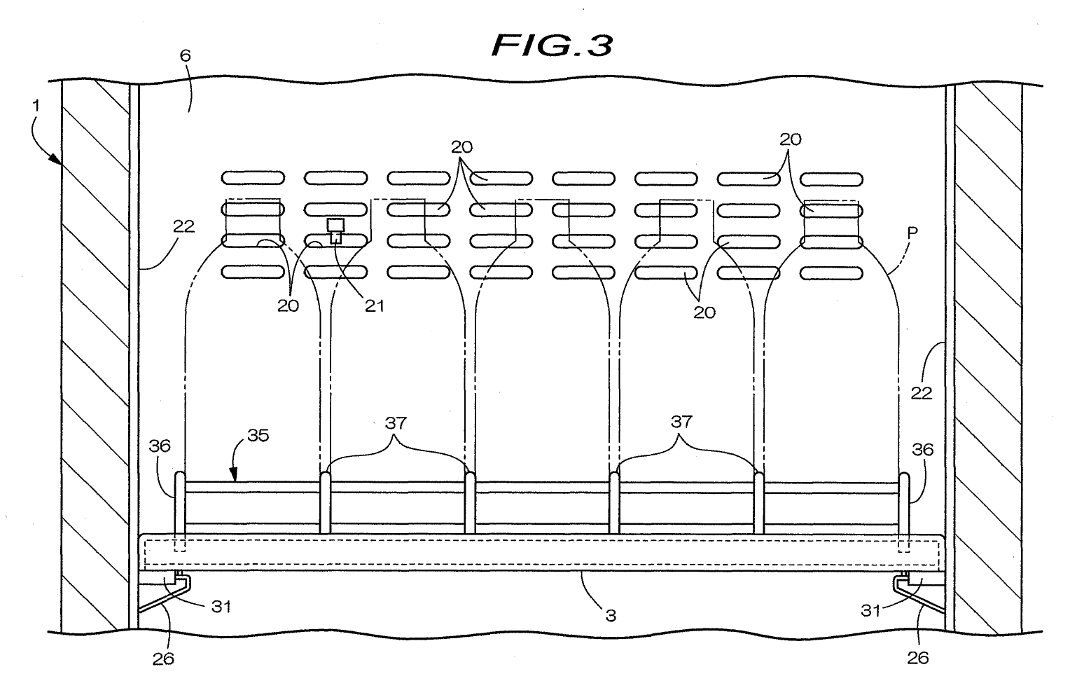

As shown in FIG. 3, the cold air supplying duct 6 has a plurality of vent holes 20, arranged along a longitudinal direction of the cold air supplying duct 6, for blowing out (supplying) the air (mixed cold air) in the cold air supplying duct 6 into the cooling room 2. Each vent hole 20 is arranged in correspondence to the shelf plate 3 of each upper and lower stage, and is arranged in a dispersed manner in the up and down direction and in a left and right direction while facing a space on the upper side of the shelf plate 3 of each stage. That is, each vent hole 20 is arranged so as to face the vicinity of the upper part of the container P arranged on the shelf plate 3 of each stage. The number or the hole diameter of the vent hole 20 arranged in correspondence to the shelf plate 3 of each upper and lower stage is set so as to reduce towards the stages on the upper side. The amount (flow rate) of cold air blown out from the vent hole 20 to each stage is thus substantially equal. The vent hole 20 may be set such that the number thereof that faces the space on the upper side of the shelf plate 3 becomes fewer towards the stages on the lower side if the passage cross sectional area of the cold air supplying duct 6 is small. In the configuration shown in FIG. 2, the cold air is blown out from each vent hole 20 in a substantially horizontal direction. Thus, the liquid drink in each container P can be reliably supercooled. The cold air blown out from each vent hole 20 passes through the inside of the cooling room 2 (third flow path 83), and is divided to that which is taken in by the cooling duct 5 and that which is taken in by the mixing unit 70.

Furthermore, the cold air supplying duct 6 faces the door 7, as described above. That is, the cold air supplying duct 6 is positioned relatively distant from the door 7. The mixed cold air supplied from each vent hole 20 of the cold air supplying duct 6 arranged as above to the cooling room 2 hits the surface on the inner side of the door 7, rises in the cooling room 2 by the operation of the intake fan 11, and taken into the intake port 10 of the cooling duct 5. The mixed cold air (air) taken in sequentially passes the cooling duct 5, the mixing unit 70, and the cold air supplying duct 6, and supplied from each vent hole 20 of the cold air supplying duct 6 to the cooling room 2. The mixed cold air supplied to the cooling room 2 is supplied to cool the liquid drink. Such circulation of air is carried out in the refrigerator.

In the refrigerator having a configuration described above, the cooling duct 5, the heat exchanger 9, and the intake fan 11 function as cooling means 85 for cooling one part of the air in the cooling room 2. A cooling unit 90 is configured by the cooing means 85 and the mixing unit 70 in the refrigerator. The cooling unit 90 is preferably removably installed with respect to the refrigerator. Therefore, the maintenance (e.g., replacement and repair) on the cooling unit 90 then can be easily performed.

A temperature sensor 21 facing one of the plurality of vent holes 20 in correspondence to the shelf plate 3 on the upper most stage is arranged in the cold air supplying duct 6. The refrigerator includes control means 56 for controlling the temperature inside based on the detection result of the temperature sensor 21. The control means 56 controls the cooling device 13, the drive motor 17 of the intake fan 11, the drive motor 19 of each fan 16, or the like. An open/close sensor for detecting the opening/closing of the door is arranged on the door 7. When the open/close sensor detects that the door 7 is opened, the control means 56 stops the rotation of the intake fan 11 and the fan 16, and suppresses the raise in the temperature inside. When the door 7 is closed, the control means 56 resumes the rotation of the intake fan 11 and the fan 16. The ratio of the amount of air taken in by the intake fan 11 and the amount of air taken in by the fan 16 is not particularly limited, but is preferably 1:1.1 to 10:1, and more preferably 1:1.1 to 1:1.5. If the ratio is within such numeral value range, supercooling is more reliably performed on the liquid drink in each container P.

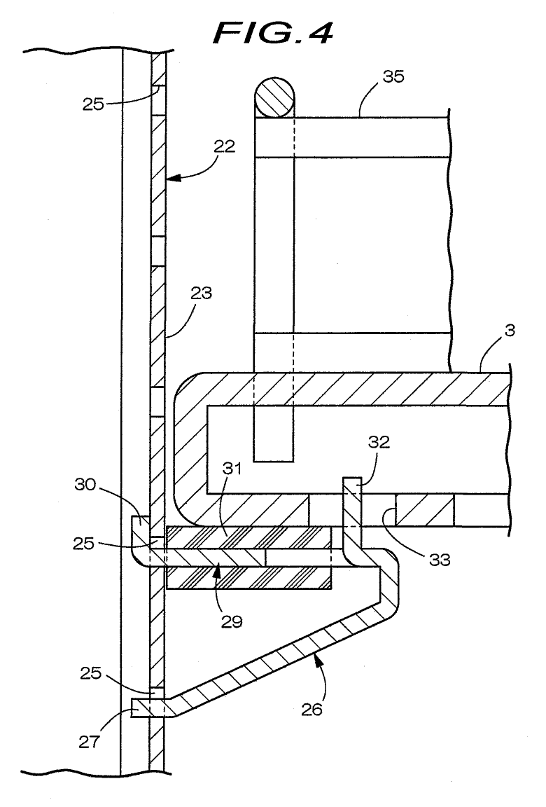

As shown in FIGS. 1 and 2, a pair of front and back shelf columns 22 is attached to left and right side surfaces on an inner surface of the cooling room 2. As shown in FIG. 4, each shelf column 22 has a side wall 23 arranged with a spacing from the side surface of the cooling room 2, and the side wall 23 faces the shelf plate 3. A plurality of attachment holes 25 for attaching a shelf receiving member 26 is formed lined in the up and down direction in the side wall 23 of each shelf column 22. Each shelf receiving member 26 is supported by the inner surface of the cooling room 2 by way of the shelf column 22. That is, each shelf plate 3 is supported by the inner surface of the cooling room 2 by way of the shelf receiving member 26 and the shelf column 22.

Each shelf receiving member 26 is removably engaged with respect to two upper and lower attachment holes 25, 25 of the shelf column 22. That is, as shown in FIG. 4, each shelf receiving member 26 has a distal end side (right side of FIG. 4) of an upper surface part 29 bent downward, and the lower end part 27 of the shelf receiving member 26 is inserted to the attachment hole 25 on the lower side and engaged and stopped when the shoulder portion of the lower end part 27 contacts the rim of the attachment hole 25. A basal end 30 (left side of FIG. 4) of the upper surface part 29 of the shelf receiving member 26 is bent upward, and the basal end 30 is inserted to the attachment hole 25 on the upper side and is engaged and stopped in a slip-off preventing manner by contacting the inner surface of the shelf column 22.

The upper surface part 29 of the shelf receiving member 26 is covered by a vibration proofing material 31 such as silicon rubber. The edge part of the shelf plate 3 is disposed on the vibration proofing material 31 (state of FIG. 4). Thus, each shelf plate 3 is arranged on the shelf receiving member 26 by way of the vibration proofing material 31, and vibration etc. of the refrigerator main body 1 is suppressed from being transmitted to the container P via the shelf receiving member 26 and the shelf plate 3. An upward projection 32 is formed on the distal end side (right side of FIG. 4) of the upper surface part 29 of the shelf receiving member 26, where projection 32 is inserted to and fitted into a fit-in hole 33 formed at the lower surface of the edge part of the shelf plate 3 thereby regulating the shift of the shelf plate 3.

A frame body 35 made of soft iron wire material is attached to the upper surface of each shelf plate 3. The frame body 35 includes a peripheral frame 36 formed so as to lie along (to a ring shape) the peripheral edge of the upper surface of the shelf plate 3, and a plurality of guide frames 37 bridged between the front and back frame parts of the peripheral frame 36. A wire rod is extended downward at four corners of the lower surface of the peripheral wall 36, and such wire rod is removably inserted and fitted into each fit-in hole 39 formed at four corners of the upper surface of the shelf plate 3, as shown in FIG. 2.

The containers P are lined between the peripheral frame 36 and the guide frame 37, or between the guide frames 37, 37 of the frame body 35. The containers P, P adjacent from side to side have the guide frame 37 interposed in between, and a gap worth the amount of the width of the guide frame 37 is created, as shown in FIG. 3. Thus, the cold air blown out from the vent hole 20 easily flows between the containers P, P, whereby each container P is rapidly and uniformly cooled.

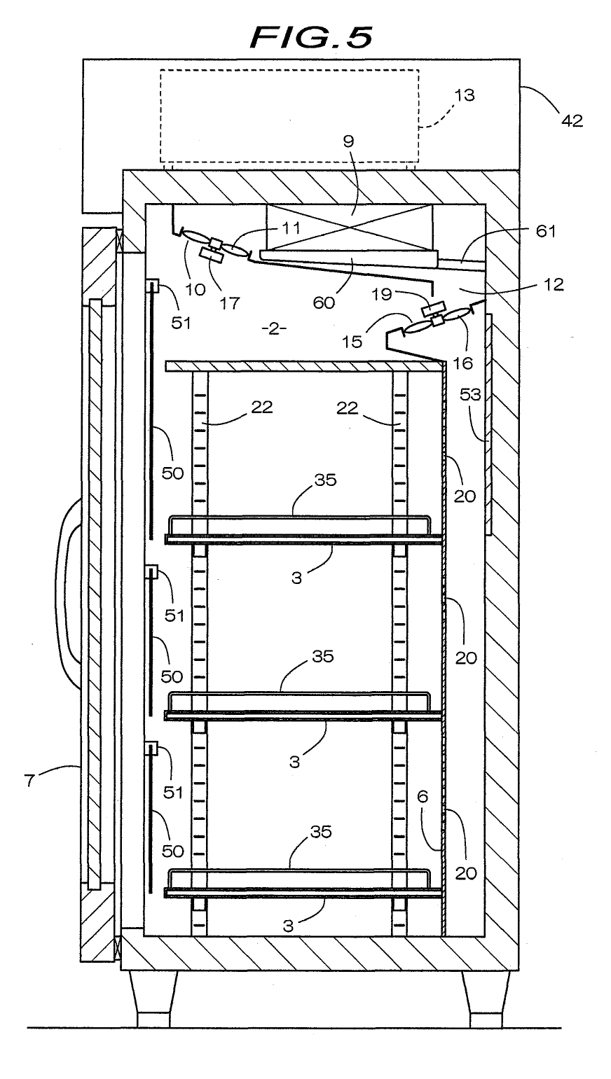

FIGS. 5 to 8 show second example of the refrigerator, which is the object of the present invention. The refrigerator of the second example is additionally arranged with a curtain 50 for covering the front surface of the opening of the cooling room 2, and a heat storage member 53 and a heater HT (defrosting heater 55) serving as temperature change alleviating means for alleviating the temperature change in the cooling room 2 with respect to the structure of the refrigerator of the first example described above. The heat storage member 53 is arranged in the cold air supplying duct 6, and the defrosting heater 55 is arranged in the vicinity of the heat exchanger 9.

In other words, as shown in FIGS. 5 and 6, a plurality of curtains 50 is arranged lined in the up and down direction with respect to the front surface of the opening of the cooling room 2. The entering of the outside air into the cooling room 2 can be reduced by arranging the curtains 50 when the door 7 is opened. Thus, temperature rise in the cooling room 2 by the opening/closing of the door 7 can be suppressed.

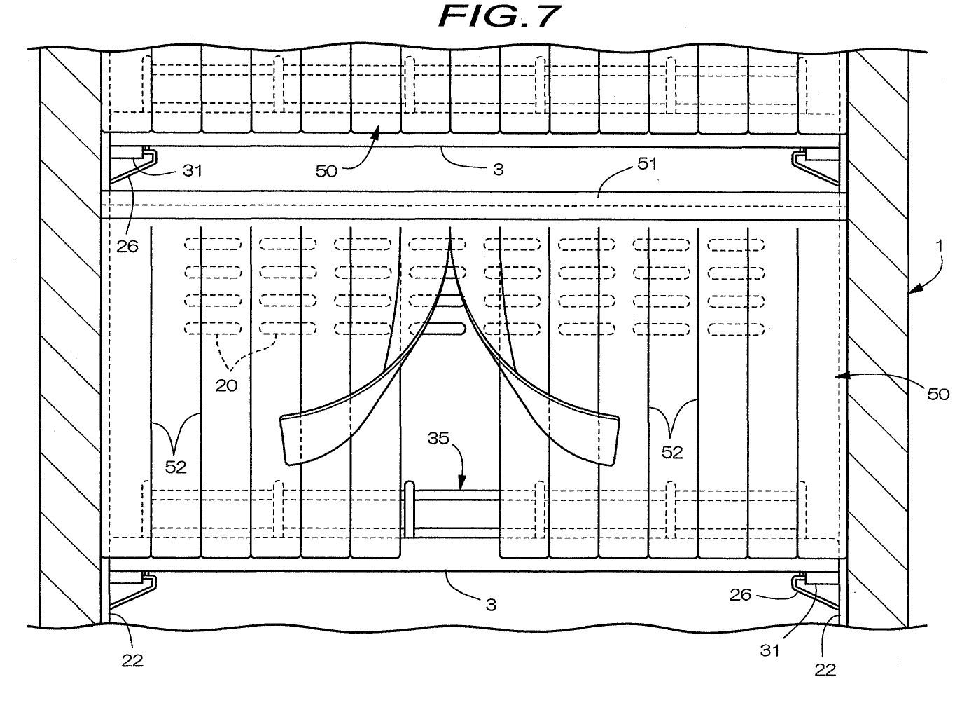

Each curtain 50 is made of transparent vinyl resin having flexibility even at low temperature, and is attached to a horizontal rod member 51 having a quadratic prism shape that is long in the left and the right. A hook that is bent downward is arranged on both left and right ends of each horizontal rod member 51. Each hook of the horizontal rod member 51 is hooked to an engagement part arranged on the left and right side surfaces of the cooling room 2, whereby the horizontal rod member 51 is bridged across the left and right side surfaces of the cooling room 2. In this state, each curtain 50 hangs from the horizontal rod member 51, and faces each space on the upper side of the shelf plate 3 of each upper and lower stage, as shown in FIG. 7. The left and right width dimension of each curtain 50 is substantially equal to the dimension between the left and right side surfaces of the cooling room 2, whereby the gap in the left and right direction between the left and right ends of each curtain 50 and the left and right side surfaces of the cooling room 2 is reduced.

Each curtain 50 is formed with a plurality of cutouts 52 extending vertically from the lower edge to the upper edge. Each cutout 52 is formed at a constant spacing in the left and right direction. When one places the container P on the shelf plate 3 or when takes the container P out from the cooling room 2, he/she opens the curtain 50 so as to widen the cutout 52 in the left and right direction or in the front and back direction.

The up and down length dimension of each curtain 50 is set so that a gap is formed between the curtain 50 on the upper side and the curtain 50 on the lower side. That is, when the rotation of the intake fan 11 and the fan 16 is resumed after the door 7 is closed, negative pressure is generated in the cooling room 2 immediately after the door 7 is closed, and the curtain 50 tends to be rapidly suctioned towards the inner side of the cooling room 2. In this case, if the up and down length dimension of the curtain 50 is large, the curtain 50 may closely attach to the shelf plate 3 or the inner surface of the cooling room 2. If such close attachment occurs, the outside air tends to easily enter inside the cooling room 2 when the door 7 is opened.

On the other hand, the difference in atmospheric pressure of the front and back of the curtains 50 becomes small as the gap is formed between the upper and lower curtains 50, as described above, whereby the curtain 50 is less likely to be suctioned towards the cooling room 2 side. Therefore, the curtain 50 is suppressed from closely attaching to the shelf plate 3 or the inner surface of the cooling room 2, and the effect of inhibiting the outside air from entering into the cooling room 2 by the curtain 50 can be maintained. As the up and down length dimension of each curtain 50 is not very large, the container P can be easily placed on the shelf plate 3, and the container P can be easily taken out from the cooling room 2.

As shown in FIG. 6, the flat heat storage member 53 is embedded to the back wall of the cold air supplying duct 6 in the vicinity of the introducing port 15 at the upper part in the cold air supplying duct 6. The heat storage member 53 is formed by accommodating cold insulator made of high polymer coagulant of gel form having a relatively large heat storage capacity in an aluminum pack formed into a bag from a film vapor deposited with aluminum. The heat storage member 53 acts to alleviate the temperature fluctuation of the air in the cold air supplying duct 6. In other words, the temperature fluctuation of the mixed cold air of the cold air blown out from the cooling duct 5 and taken into the cold air supplying duct 6 and the air taken in from the cooling room 2 into the cold air supplying duct 6 is suppressed by the heat storage member 53, and the temperature fluctuation of the cooling room 2 also reduces therewith. Furthermore, the temperature rise in the cooling room 2 is suppressed by the heat storage member 53 even if the defrosting heater 55 for removing the frosts of the heat exchanger 9 is turned ON. The freezing temperature of the heat storage member 53 is −15 to 0° C. The heat storage member 53 is preferably made of a material having a heat storage capacity larger than metal materials and may be that in which water is accommodated in aluminum pack, ceramic, and the like.

In the cold air supplying duct 6, the heater HT is arranged in the vicinity of the temperature sensor 21, that is, the upper part in the cold air supplying duct 6. The heater HT is fixed to the front surface of a supporting plate 62 extending in the left and right width direction of the cold air supplying duct 6. When the heater HT is turned ON, the lowering in temperature in the cooling room 2 by the operation of the heat exchanger 9 becomes gradual. The transmission of heat of the heater HT to the heat storage member 53 positioned on the back side of the heater HT is reduced since the supporting plate 62 is arranged.

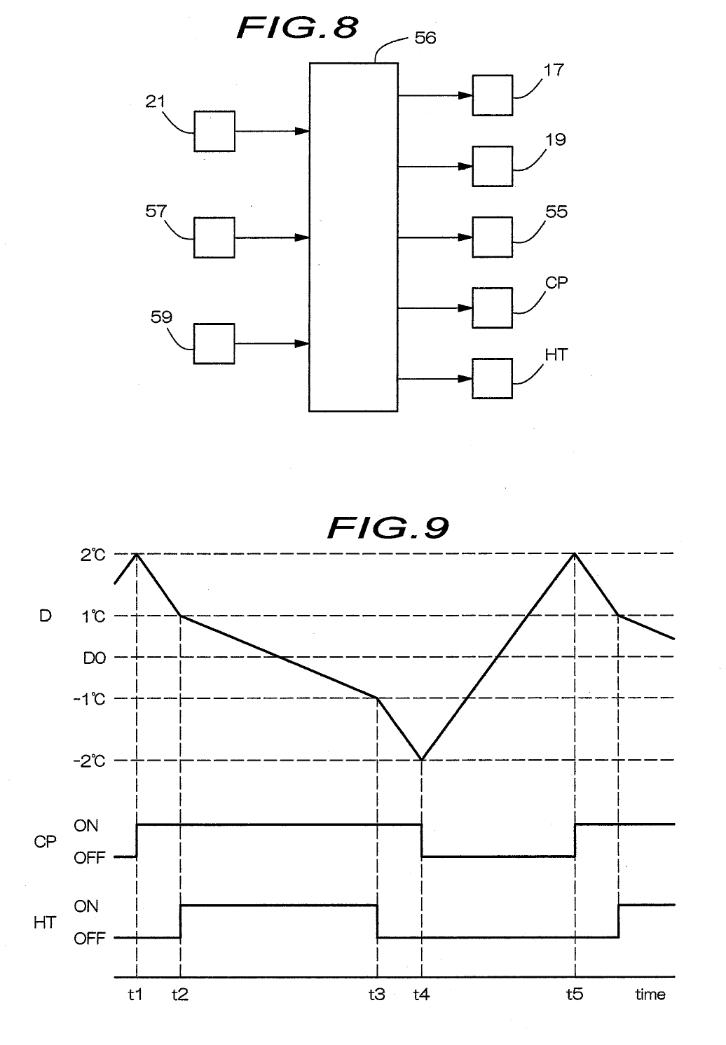

The control means 56 shown in FIG. 8 controls the compressor CP of the cooling device 13, the drive motor 17 of the intake fan 11, and the like so that the temperature inside detected by the temperature sensor 21 is within a temperature range set in advance. The control means 56 turns ON the compressor CP, the drive motor 17 of the intake fan 11, and the like when the temperature inside becomes higher than the set temperature set in advance by an operation unit 57 etc. by e.g. 2° C., and turns OFF the compressor CP, the drive motor 17 of the intake fan 11, and the like when the temperature inside becomes lower than the set temperature by e.g. 2° C. The ON/OFF switching of the drive motor 17 and the like is repeated according to the temperature inside.

When the open/close sensor 59 detects that the door 7 is opened, the control means 56 turns OFF the drive motor 17 of the intake fan 11 and the drive motor 19 of each fan 16 to forcibly stop the rotation of the intake fan 11 and the fans 16. When the open/close sensor 59 detects that the door 7 is closed, the control means 56 resumes the ON state of the drive motor 17 of the intake fan 11 and the drive motor 19 of each fan 16. The control means 56 maintains the drive motor 19 of each fan 16 in the ON state while the door 7 is closed. The operation unit 57 includes a temperature setting switch, and the like.

The control means 56 also controls the heater HT based on the temperature inside. As shown in FIG. 9, the control means 56 turns ON the compressor CP etc. of the cooling device 13 when a temperature inside D becomes higher than a set temperature D0 by e.g. 2° C. at time t1. The temperature inside D thereby lowers, and the control means 56 turns ON the heater HT when the temperature inside D lowers to the ON temperature set in advance that is higher by e.g. 1° C. than the set temperature D0 at time t2. Furthermore, after turning ON the heater HT, the control means 56 turns OFF the heater HT when the temperature inside D lowers to the OFF temperature set in advance that is lower than the set temperature D0 by e.g. 1° C. at time t3.

Subsequently, the control means 56 turns OFF the compressor CP etc. of the cooling device 13 when the temperature inside D becomes lower than the set temperature D0 by e.g. 2° C. at time t4. The temperature inside D rises when the compressor CP etc. of the cooling device 13 is turned OFF, and the control means 56 again turns ON the compressor CP etc. of the cooling device 13 when the temperature inside D becomes higher than the set temperature D0 by e.g. 2° C. at time t5. Other aspects are the same as example 1, and thus the description thereof will be omitted. The OFF temperature is set lower than the ON temperature.

Therefore, the temperature inside D gradually lowers by turning ON the heater HT while the compressor CP etc. of the cooling device 13 is turned ON. The time interval of switching from ON to OFF of the compressor CP etc. of the cooling device 13 increases by such amount, and the number of ON/OFF switching of the compressor CP etc. of the cooling device 13 reduces. Therefore, faults of the compressor CP etc. of the cooling device 13 caused by frequent turning ON/OFF of the compressor CP etc. of the cooling device 13 are reduced. Furthermore, since the temperature inside D gradually lowers, the overshoot of the temperature inside D caused by response delay of the temperature inside D with respect to the temperature detection by the temperature sensor 21 can be prevented.

The ON time of the compressor CP etc. of the cooling device 13 is desirably made as long as possible, and to this end, consideration is made in extending the ON time of the heater HT. However, the cooling room 2 might be warmed in excess if the ON time of the heater HT becomes three or more minutes, in which case, the control means 56 forcibly turns OFF the heater HT. The temperature range of the temperature inside D with respect to the set temperature D0 is preferably small, and is preferably smaller than or equal to 3° C. The temperature at which the heater HT is turned ON and the temperature at which the compressor CP etc. of the cooling device 13 is turned ON may be the same, or the temperature at which the heater HT is turned OFF and the temperature at which the compressor CP etc. of the cooling device 13 is turned OFF may be the same.

The heater HT may be arranged in the cooling room 2 or in the cooling duct 5. The heater HT may include the defrosting heater 55. In this case, the frost attached to the heat exchanger 9 melts and thus removes when the defrosting heater 55 is turned ON. The frost may attach to the heat exchanger 9 in excess due to high humidity and the like, in which case, the defrosting heater 55 is forcibly turned ON by operating the operation unit 57 to remove the frost. The water produced by the frost melting is drained to the outside of the refrigerator via a drain pan 60 and a drain pipe 61 shown in FIG. 6.

The heater HT for gradually lowering the temperature inside D may be configured only by the defrosting heater 55. In the first example, an air curtain may be formed on the front surface of the opening of the cooling room 2.

The temperature sensor 21 is installed near the shelf plate 3 of the upper most stage, but is not limited thereto, and a plurality of temperature sensors 21 may each be arranged with respect to each shelf plate 3. In this case, the plurality of temperature sensors 21 is preferably arranged at the same position with respect to each shelf plate 3. The temperature management of the inside of the cooling room 2 etc. is thereby reliably performed.

The cold air supplying duct 6 is installed on the rear surface side of the cooling room 2 in the present embodiment, but is not limited thereto, and may be installed on at least one of left or right side surface in FIG. 3 of the cooling room 2. If the cold air supplying duct 6 is installed on at least one of the side surfaces of the cooling room 2, the door can also be installed on the rear surface of the cooling room 2. Thus, one can open the door on either the front surface side or the rear surface side of the cooling room 2 in order to place or take out the container P in or from the cooling room 2.

The fan 16 and the intake fan 11 are configured such that the respective number of rotations can be appropriately changed. Thus, the absolute amount of the amount of wind by each fan or the ratio of the amount of wind can be changed.

1. A refrigerator comprising:
a cooling room for accommodating a container of liquid drink;
a heat exchanger for cooling air inside the cooling room;
a cooling duct incorporating the heat exchanger;
an intake port arranged on one part of the cooling duct;
a cold air blow-out port arranged at a position different from the intake port of the cooling duct;
a cold air supplying duct for circulating the air in the cooling room;
an introducing port arranged on one end of the cold air supplying duct;
a vent hole for blowing out the air in the cold air supplying duct into the cooling room; and
a fan attached facing the introducing port of the cold air supplying duct; wherein
the cooling duct takes in air in the cooling room from the intake port and cools the air with the heat exchanger, and thereafter blows out air from the cold air blow-out port;
the cold air supplying duct is arranged in the up and down direction of the cooling room at a side surface of the cooling room, the introducing port faces the cold air blow-out port of the cooling duct and faces the inside of the cooling room; and
air is taken in from the introducing port into the cold air supplying duct by the fan.

2. The refrigerator according to claim 1, wherein an opening area of the introducing port of the cold air supplying duct is larger than an opening area of the cold air blow-out port of the cooling duct, one part of the introducing port of the cold air supplying duct faces the cold air blow-out port of the cooling duct, and one part of the introducing port of the cold air supplying duct faces the inside of the cooling room.

3. The refrigerator according to claim 2, further comprising an intake fan facing the intake port of the cooling duct; wherein
the air is taken in from the intake port of the cooling duct to the inside of the cooling duct by the intake fan.

4. The refrigerator according to claim 3, wherein the amount of wind of the fan is set to be larger than the amount of wind of the intake fan.

5. The refrigerator according to claim 4, wherein
a front surface of the cooling room is opened, and a door for opening/closing the front surface of the opening of the cooling room is arranged;
the cooling duct is arranged on a roof side of the cooling room;
the intake port of the cooling duct is arranged diagonally downward;
the cold air blow-out port of the cooling duct is arranged downward; and
the introducing port of the cold air supplying duct is arranged diagonally upward at the upper end of the cold air supplying duct, and faces the cold air blow-out port of the cooling duct.

6. The refrigerator according to claim 1, wherein
a shelf plate is arranged in plurals in the up and down direction;
the vent hole is arranged in plurals in the cold air supplying duct; and
each vent hole is arranged dispersed in the up and down direction and in the left and right direction in a state of facing a space on the upper side of the shelf plate of each upper and lower stage.

7. The refrigerator according to claim 6, wherein the vent hole arranged in the space on the upper side of the shelf plate of each upper and lower stage is set so that the number and/or hole diameter of the vent hole facing the space on the upper side of the shelf plate reduces towards the stages on the upper side.

8. The refrigerator according to claim 6, wherein the vent hole arranged in the space on the upper side of the shelf plate of each upper and lower stage is set so that the number and/or hole diameter of the vent hole facing the space on the upper side of the shelf plate reduces towards the stages on the lower side.

9. The refrigerator according to claim 1, further comprising:
a door for opening/closing the front surface of the cooling room which is opened; and
a plurality of curtains arranged lined in the up and down direction at the front surface of the opening of the cooling room.

10. The refrigerator according to claim 9, wherein
a shelf plate is arranged in plurals in the up and down direction; and
each curtain is arranged on each shelf plate of each upper and lower stage.

11. The refrigerator according to claim 10, wherein an up and down length dimension of each curtain is set so as to form a gap between the curtain on the upper side and the curtain on the lower side

12-13. (canceled)

14. The refrigerator according to claim 1, wherein
a shelf plate for mounting the container;
a shelf receiving member supported by the inner surface of the cooling room; and
a vibration proofing material for covering the upper surface of the shelf receiving member are arranged in the cooling room; and
the shelf plate is mounted on the shelf receiving member by way of the vibration proofing material.

15-18. (canceled)

19. The refrigerator according to claim 1, wherein
a frame body including a peripheral frame formed along the peripheral edge of the upper surface of the shelf plate and a guide frame bridged on the inner side of the peripheral frame is arranged on the upper surface of the shelf plate; and
the guide frame is interposed between the containers adjacent to each other.

20. The refrigerator according to claim 1 further comprising:
a temperature sensor facing the vent hole; and
control means for ON/OF controlling a cooling device connected to the heat exchanger based on the temperature inside detected by the temperature sensor so that the temperature inside is within the temperature range set in advance.

21. The refrigerator according to claim 20, wherein
a shelf plate is arranged in plurals in the up and down direction in the cooling room
the vent hole is arranged in plurals in the cold air supplying duct;
each vent hole is arranged facing the space on the upper side of the shelf plate of each upper and lower stage; and
the temperature sensor is arranged in the vent hole facing the space on the upper side of at least one shelf plate.

22. The refrigerator according to claim 20, further comprising:
a door for opening/closing a front surface of the cooling room which is opened;
an open/close sensor for detecting the opening/closing of the door; and
an intake fan, attached so as to face the intake port of the cooling duct, for taking in air from the intake port of the cooling duct into the cooling duct; wherein
the control means stops the rotation of the intake fan and the fan when the open/close sensor detects that the door is opened.

23. The refrigerator according to claim 20, wherein
a heater is arranged in the cooling room; and
the control means turns ON the heater when the temperature inside becomes an ON temperature set in advance after the cooling device is turned ON.

24. The refrigerator according to claim 23, wherein the controls means turns ON the heater, and thereafter, turns OFF the heater when the temperature inside becomes an OFF temperature set in advance which is lower than the ON temperature.

25. The refrigerator according to claim 24, wherein the OFF temperature is set to higher than or equal to the temperature inside at which the temperature inside lowers and the cooling device is turned OFF.

26. The refrigerator according to claim 25, wherein the heater is arranged in the cold air supplying duct.

27. The refrigerator according to claim 25, wherein the heater includes a defrosting heater arranged in the heat exchanger.

28. The refrigerator according to claim 25, wherein the heater is configured only with the defrosting heater.

29-31. (canceled)

32. The refrigerator according to claim 1, storing the container accommodating liquid drink at a temperature of lower than or equal to a freezing point of the liquid drink and in a supercooled state in which the liquid drink is maintained unfrozen.

33. A refrigerator for storing a container accommodating liquid drink at a temperature of lower than or equal to a freezing point of the liquid drink and in a supercooled state in which the liquid drink is maintained unfrozen; the refrigerator comprising:
a cooling room for accommodating the container;
cooling means for cooling one part of the air in the cooling room;
a mixing unit for mixing the cold air cooled by the cooling means and one part of the air in the cooling room; and
cold air supplying means for supplying the mixed cold air mixed in the mixing unit into the cooling room; wherein
the liquid drink in the container is supercooled by the mixed cold air supplied via the cold air supplying means.

34. The refrigerator according to claim 33, wherein the cooling means includes a cooling duct with an intake port for taking in one part of the air supplied to cool the liquid drink in the container in the cooling room and a cold air blow-out port for blowing out air taken in from the intake port, and a heat exchanger for cooling the air passing through the cooling duct.

35. The refrigerator according to claim 34, wherein the cooling duct is installed on the roof side of the cooling room.

36. The refrigerator according to claim 34, wherein the cooling means further includes an intake fan, installed at the intake port, for taking in air into the cooling duct through the intake port.

37. The refrigerator according to claim 33, wherein the mixing unit includes a mixing unit main body having an introducing port opened to the vicinity of the cold air blow-out port, and a fan, arranged in the vicinity of the mixing unit main body, for introducing the air blown out from the cold air blow-out port and the air supplied to cool the liquid drink in the container in the cooling room from the introducing port to the mixing unit main body.

38. The refrigerator according to claim 33, wherein the cold air supplying means includes a cold air supplying duct communicating to the mixing unit and having a vent hole through which the mixed cold air introduced from the mixing unit blows out to the cooling room.

39. The refrigerator according to claim 38, wherein the cold air supplying duct is arranged along one side surface of the cooling room.

40. The refrigerator according to claim 39, wherein
a freely opening/closing door is installed on a front surface of the cooling room; and
the cold air supplying duct is arranged on a rear surface side of the cooling room.

41. The refrigerator according to claim 38, wherein the cold air supplying duct is arranged in the vertical direction, is formed with the vent hole in plurals along a longitudinal direction, and is configured to blow out the mixed cold air from each vent hole towards the cooling room.

42. (canceled)

43. The refrigerator according to claim 41, wherein the number and/or hole diameter of the vent hole is adjusted so that the flow rate of the mixed cold air supplied from each vent hole corresponding to each shelf plate is substantially equal.

44. (canceled)

45. The refrigerator according to claim 37, wherein a ratio of an amount of air taken into the cooling means and an amount of air taken into the mixing unit is 1:1 to 1:2.

46. The refrigerator according to claim 33, further comprising temperature change alleviating means for alleviating the temperature change in the cooling room.

47. (canceled)

48. The refrigerator according to claim 46, wherein the temperature change alleviating means is a heater which operates at a predetermined time.

49-50. (canceled)

51. A cooling unit arranged and used in a refrigerator including a cooling room for storing a container accommodating liquid drink at a temperature of lower than or equal to a freezing point of the liquid drink and in a supercooled state in which the liquid drink is maintained unfrozen, and a cold air supplying means for supplying air to the cooling room; the cooling unit comprising:
cooling means for cooling one part of the air in the cooling room; and
a mixing unit for mixing the cold air cooled by the cooling means and one part of the air in the cooling room, and sending the mixed cold air to the cold air supplying means; wherein
the liquid drink is supercooled by the mixed cold air supplied through the cold air supplying means.

52-53. (canceled)
